(19) United States
(12) Patent Application Publication
(10) Pub. No.: US 2021/0336951 A1
(43) Pub. Date: Oct. 28, 2021

(54) FUSION TEMPLATE FOR USER AUTHENTICATION AND VAULT FOR STORING AND USING THE SAME

(71) Applicant: AWARE, INC., Bedford, MA (US)

(72) Inventors: Mohamed LAZZOUNI, Northborough, MA (US); Robert ECKEL, Andover, MA (US)

(21) Appl. No.: 17/234,037

(22) Filed: Apr. 19, 2021

Related U.S. Application Data
(60) Provisional application No. 63/013,723, filed on Apr. 22, 2020.

(51) Int. Cl. H04L 29/06; G06F 21/40; G06F 21/32

(52) U.S. Cl. CPC H04L 63/0861; G06F 21/32; G06F 21/40

(57) ABSTRACT

Methods and systems are provided that allow a user to store, provision, and control a plurality of biometric and non-biometric modalities associated with the user. An IntelliVault allows the user to securely store and utilize biometric information and provides sovereign data management to the user for access authentication.

The present application claims the benefit of and priority, under 35 U.S.C. § 119(e), to U.S. Provisional Application Ser. No. 63/013,723, filed on Apr. 22, 2020, entitled “FUSION TEMPLATE FOR USER AUTHENTICATION AND VAULT FOR STORING AND USING THE SAME,” the entire disclosure of which is hereby incorporated by reference, in its entirety, for all that it teaches and for all purposes.

### FIELD

Exemplary aspects of present disclosure are generally directed to storing and using biometric and other information for verification/authentication and, in particular, toward securely storing, provisioning, and utilizing a plurality of biometric and non-biometric user information to promote sovereign data management. Exemplary aspects of the present disclosure may additionally allow a user flexibility in the security and usability of the user information by providing the user a slidable scale to adjust the security and/or usability the user's personal data.

### BACKGROUND

The recent explosion of technological advancements has caused a drastic change in the methods and practices of authenticating and verifying digital information as well as governing the access thereto. To cope with the adjustments necessary in an evolving digital landscape, businesses, governmental agencies and academic institutions have begun to shift away from physical identify verification and have begun to use digital verification. Digital verification is often used to verify the identity of the individual before allowing the individual access to a service provider's resources or other information.

Often, the current digital authentication technology relies on a large disclosure of information upon first contact with the service provider or other entity, and additional information for authentication in any follow-up or continued use of the service. For example, many businesses may require an individual to input various forms of information, such as their social security number, street address, and name, among other types of information, when the individual first contacts the business.

Once initial contact with the service provider or other entity has been established, the user may then be required to set up one or more forms of authentication to permit further use of the service. This authentication is typically conducted by prompting the user for a piece of information known to the user, and which is presumed to be unique or only known to the user. Digital verification can take place in a number of ways, such as with the use of a password, PIN, dual factor authentication or other form of access credentials input by the user to access services.

Some services require additional authentication factors. For instance, some services may require the user to set up a multiple-factor authentication before accessing the services. The single-factor authentication may take the form of a single user verification, such as when the user enters a password or PIN to access their bank account. A multi-factor authentication may require additional authentication to obtain access to services, such as a user entering their password and additionally a one-time password that is sent to their email or text their phone by the business. Often, the additional authentication is another piece of information that the business has obtained from the user, and is prompting the user to re-enter to confirm the digital identity of the individual. The business may then compare the user's input with information already stored at a central server in the business and, upon confirmation of the authentication information, permit the user access to their services or information.

As previously mentioned, currently the service providers require the user to share their information with the service provider, and then re-enter that information later as a method of authentication to gain access or complete transactions with the service provider. The service provider usually takes large amounts of information from the individual, stores the information in a central server, and uses some or all of that data to verify the user whenever the user wishes to conduct a transaction. Moreover, the individual is left without alternatives to the current method for accessing services. The upfront disclosure of information is non-negotiable, and the individual is at the mercy of the service provider in terms of how much information is disclosed, and in many cases not relevant to the service requested and of no control of the user and what type(s) of information used to authenticate the user.

While some service providers may need only a small amount of information to conduct transactions, other service providers require large upfront deposits of information to access their services. For example, signing up for a health insurance provider usually requires a thorough disclosure of the financial, behavioral, and medical history from an individual. This process provides the insurance company with a plethora of valuable personal information about the individual. While the user may determine that some of the personal information is not and/or should not be required for the transaction of services, the user must nonetheless offer up the information desired by the service provider in exchange for the service.

Further, services providers often share the information obtained from the user with other corporations and/or data farms, with little regard to the individual, resulting in large quantities of personal information being stored at multiple sites across multiple digital landscapes, many of which are outside of the user's control or the user can only acknowledge and must accept to continue the service.

Currently, there is no method that allows the individual sovereign control over their data. Whether it is attempting to access their bank account or sign up for an online subscription, the individual must enter their personal data with little to no knowledge to what extent their data either in whole or part will be stored, shared, or mismanaged, or the security thereof.

The widespread nature of the sharing of personal information and the storing thereof in central servers leaves individuals susceptible to data breaches. Hacking has become more sophisticated in the past two decades, and often corporations or central server management are unaware that they have been hacked and that the data of their users has been breached until it is too late. While the individual is not at fault for the data breach, the individual is nonetheless negatively impacted. Moreover, the user has no option but to provide their personal data to service providers in order to conduct transactions with or through the service provider. As can be appreciated, the lack of control over personal data can be frustrating and limiting.

### SUMMARY

There is a need for a paradigm shift when it comes to user authentication.

One exemplary non-limiting embodiment of the present disclosure may be an IntelliVault stored on a user device or device of the user's choice. The IntelliVault may be designed to hold information associated with the user. The information may be biometric information, non-biometric information, combinations thereof or multiple combinations thereof.

Moreover, the user may be able to logically combine the information to form fusion templates of data. The fusion templates may contain various mixtures of biometric and/or non-biometric information. The fusion templates may have several advantages associated therewith. In addition to being a unique formulation of individual information, fusion templates may be highly flexible and provide the user with increased security for their individual information. As a non-limiting example of increased security, current statistics indicate that the user may share the same iris scan as every 1 person in 2,000,000 people. Moreover, the user may share the same face scan as every 1 person in 100,000 people. This low repetition of biometric modalities gives higher security to the user than if the user were to implement a non-biometric modality (e.g., a password) for security purposes. However, the user may still be susceptible having their data compromised. Exemplary aspects of the present disclosure may permit the user to combine both the iris scan and the face scan into a fusion template, creating a unique verification method that is greater than the sum of the security of the iris scan and the security of the face scan. Additionally, the fusion template can be compressed (to save, for example, storage space) and still provide improved security over singular modalities. The resulting combination of the digital information in the fusion template introduces additional security orders of magnitude higher than if the user were to individually implement an iris scan or a face scan, or if the user were to implement both as separate forms of digital authentication. However, the present disclosure is not limiting to fusion templates, and may permit the user to implement a single modality for security purposes if the user wishes to do so. Moreover, the fusion template is not limited to just the iris scan and the face scan, and additional or alternative modalities may be used. For instance, the fusion template may be a combination of any number of biometric and/or non-biometric modalities. The fusion templates may additionally increase the level of security with every additional biometric or non-biometric modality infused therein. This level of security and uniqueness in authentication may allow the user increased comfort in the security of their data and transactions therewith. For example, the user may determine that some transactions or verifications may be more valuable to bad actors or hackers (e.g., bank account information) than others (e.g., information obtained from a hacked service provider) and may provision his data to address this (e.g., requiring more information or a higher level of security to verify the user when accessing a bank account than when accessing a streaming service).

Moreover, the fusion templates are flexible in their use. For instance, the user may be able to choose which transactions utilize which templates, allowing the user to determine the extent to which the user's data is sent to third parties. For instance, the user may use more templates for transactions that the user deems more significant or valuable, and may use fewer templates for transactions that the user deems less significant or less valuable. This flexibility allows the user to determine just how much data is shared, and with which service provider. For example, the user may determine that opening a new email account does not require that the email service provider know the user's home address, phone number, and date of birth. Accordingly, the user may choose to simply use a fingerprint and a password to verify the user's identity, and may therefore keep personal information related to the user's home address, phone number, and date of birth under their own domain. To verify the identity of the user, the user may send a fusion template containing digital information related to the user's fingerprint and password to a third party as a means of authentication to verify the user and open the email account. It should be noted that the fusion template is not a set of serial modalities; rather, the fusion template may be a blending or fusing of various information related to the user's fingerprint and password. Additionally, in some embodiments, only the user is aware of which types of information are included in the fusion template, which third parties from reverse engineering the exact digital information underlying the fusion template.

Some non-limiting examples of fusion that can be used with any one or more of the embodiments disclosed herein are:
1. J. P. Hube. Neyman-Pearson Biometric Score Fusion as an Extension of the Sum Rule, SPIE Biometric Technology for Human Identification IV, Orlando, Fla., 2007.
2. J. P. Hube. Formulae for consistent biometric score level fusion, 2017 IEEE International Joint Conference on Biometrics (LTCB), Denver, Colo., 2017, pp. 329-334.

Both of which are incorporated herein by reference in their entirety.

As another non-limiting example and benefit of the current technology, the blending or fusing of the various information in a fusion template helps obfuscate the underlying information, providing an additional security benefit. For example, and as discussed herein, information (such as a fingerprint, birthdate and an image) can be combined for the fusion template. While this blended or fused information is nonsensical to a human, it provides a very unique and robust package of information that can be used, for example, for authentication to access a bank account.

As another non-limiting example, the user may wish to share limited information when conducting various transactions. For instance, the user may prefer that information related to their street address and date of birth are not shared with a bank when they move money from their savings account to their checking account. In this instance, the user may choose to authenticate the transaction without using the street address and date of birth, but rather with some other form of authentication. Hence, the user has sovereign data management; the user chooses how much and in which forms information is disclosed to the service provider.

One exemplary advantage of the current disclosure is the introduction of sovereign data management. In contrast to the current paradigm, where the user must fully disclose personal information that may be compromised in the future, the present disclosure may permit the user full control over their personal information. In other words, the user has complete freedom to utilize their data as they see fit and the service provider will provide access. This paradigm shift may now give the user the responsibility of personal data management, and allows the user to have complete control over their own identity and allows the user to decide how much security should be used for a specific transaction or class of transactions. The present disclosure does not force the user to any specific template for any particular transaction; in contrast, the user has the flexibility to choose how and in which forms they provision their data. This introduced flexibility and freedom are unprecedented, and provides full control to the user to determine how they use their personal data in any manner they deem satisfactory.

Another exemplary advantage of the present disclosure is the protection of the individual identity of the user. By securing biometric data and provisioning the biometric data using fusion templates, the biometric data associated with the user is protected and, by extension, so is the user's identity. In the event that a hacker were able to intercept a fusion template sent from the user, the hacker would have no way of re-forming the individual biometric information from the fusion template, since the blending or fusing of the modalities yields a sophisticated authentication that cannot be easily deconstructed into individual modalities. Moreover, by storing the biometric data in an IntelliVault, the user gains the advantage of securely protecting their biometric information while simultaneously reducing the risk that their data be compromised.

Another exemplary advantage is the reduction of individual data being compromised. As previously noted, the centralized identification paradigm provides large amounts of personal information for a huge number of users at a centralized location. One sophisticated and successful hack could potentially compromise information for millions of individuals (and has). The current disclosure is directed toward individual data management; in order to comprise the same amount of data, a hacker would have successfully hack millions of devices. This data movement would severely discourage and limit the hacking of personal information.

Another exemplary advantage of the present disclosure is user comfort in the security of their personal information. While current digital authentication spreads large amounts of user data across multiple platforms, the present disclosure is directed toward allowing users to determine the extent to which they share information. For instance, the user may deem it unnecessary to send large amounts of personal information to a service provider in exchange for their service, and may therefore provision a small amount of data for authentication to the service provider to access the service. This may limit the amount of personal information the user discloses, which limits the amount of personal information that may be compromised.

Another exemplary advantage of the present disclosure is an increased security level of transactions. As previously noted, biometric information is often highly unique, and cannot be easily replicated. Further, the use of fusion templates, which may take more than one modality associated with the user and logically combine them (through, for example combinatorial logic or any other means), ensures that replication is near impossible or impossible, and that only transactions that the user implements may succeed. In some embodiments of the present disclosure, the logical combination may be randomly updated or changed at random time intervals (e.g., daily, weekly, monthly, etc.) to provide an additional level of security. This may provide the user with a level of comfortability previously unknown, since while a single biometric modality is difficult to forge, highly-complex logical combinations of multiple biometric modalities may provide a high level of security in the user-initiated transactions.

Another exemplary advantage is the reduction in time necessary to complete a transaction. In conventional authentication, the user sets up a first encounter with the service provider, as well as authentication steps for follow-up interactions. In contrast, the present disclosure allows a single data transaction between the service provider and the user; the user may select their own data and amount thereof to authenticate a transaction. The service provider may only receive the request for the transaction, as well as an authentication thereof, and may issue the service without further inquiry. This may allow the user to more quickly conduct transactions at the ease and desirability of the user, without having to rely on the service provider to determine the speed of the transaction.

These and other benefits and advantages can be realized based on one or more of the exemplary aspects described herein.

### BRIEF DESCRIPTION OF THE DRAWINGS

FIG. 1 shows an IntelliVault in accordance with aspects of the present disclosure;

FIG. 2A shows a templates module interface in accordance with aspects of the present disclosure;

FIG. 2B shows a fusion template constructed from existing templates in accordance with aspects of the present disclosure;

FIG. 2C shows another fusion template constructed from existing templates in accordance with aspects of the present disclosure;

FIG. 3 shows an isometric view of layered templates and a fusion template constructed therefrom in accordance with aspects of the present disclosure;

FIG. 4A shows a dial system depicting low security and high usability of the IntelliVault in accordance with aspects of the present disclosure;

FIG. 4B shows a dial system depicting high security and low usability of the IntelliVault in accordance with aspects of the present disclosure;

FIG. 5 is a template rules module interface with a low security setting in accordance with aspects of the present disclosure;

FIG. 6 is a template rules module interface with a high security setting in accordance with aspects of the present disclosure;

FIG. 7 is a usage rules module interface with a low security setting in accordance with aspects of the present disclosure;

FIG. 8 is a usage rules module interface with a high security setting in accordance with aspects of the present disclosure;

FIG. 9 is a flow diagram illustrating example operations of the system(s) in FIGS. 1-8 in accordance with the aspects of the present disclosure;

FIG. 10 is a flow diagram illustrating example operations of the system(s) in FIGS. 1-8 in accordance with the aspects of the present disclosure;

FIG. 11 is a flow diagram illustrating example operations of the system(s) in FIGS. 1-8 in accordance with the aspects of the present disclosure; and

FIG. 12 is a flow diagram illustrating example operations of the system(s) in FIGS. 1-8 in accordance with the aspects of the present disclosure.

### DETAILED DESCRIPTION

Exemplary aspects of the present disclosure will be described in connection an IntelliVault. Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practice or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

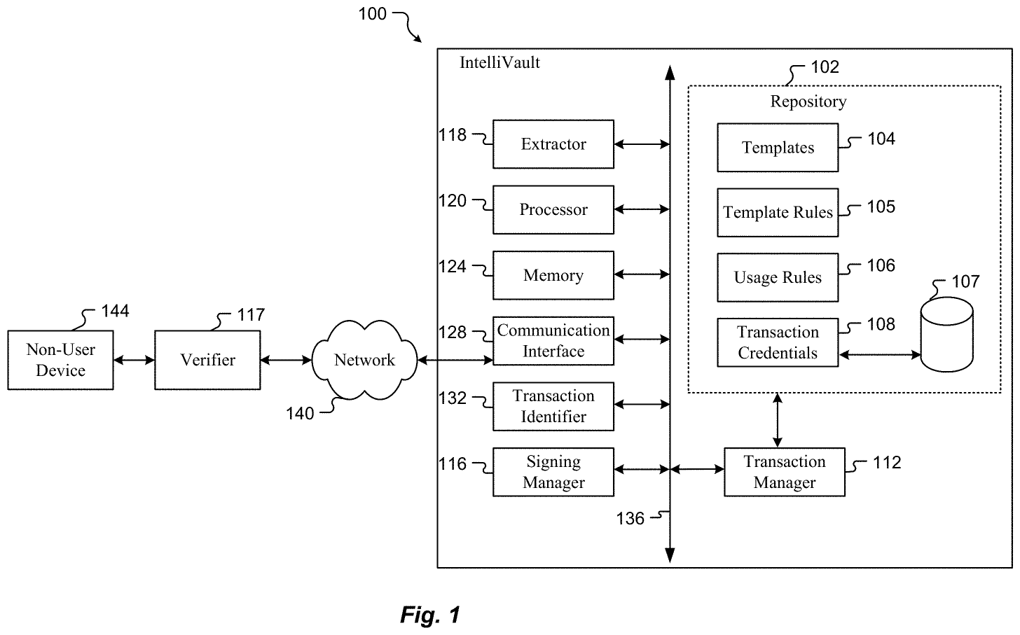

FIG. 1 illustrates an IntelliVault 100 in accordance with embodiments of the present disclosure. The IntelliVault 100 described herein permits a user to store, provision, and control a plurality of biometric modalities associated with the user. In some embodiments, the IntelliVault 100 may be stored in a user device. The user may be able to access the IntelliVault 100 through the user device or may be able to access the IntelliVault 100 remotely. The user device is not particularly limiting, and the user device may be, but is in no way limited to, smartphones, cameras, wearables (e.g., smart glasses, smart clothing), smart technologies (e.g., smart TV), computers, laptops, tablets, and/or any device capable of capturing and/or managing one or more biometric and/or non-biometric modalities associated with a user.

The IntelliVault 100 comprises a repository 102, a transaction manager 112, a signing manager 116, an extractor 118, a processor 120, a memory 124, a communication interface 128, and a transaction identifier 132. The transaction manager 112, the signing manager 116, the extractor 118, the processor 120, the memory 124, the communication interface 128, and the transaction identifier 132 may be in communication with one another, as well as with other components of the IntelliVault 100, as indicated by communication arrows 136. The communication between the components of the IntelliVault 100 may be made through either wired or wireless connectivity. The communication of the components of the IntelliVault 100 are not limited to the embodiment shown in FIG. 1, and any component of the IntelliVault 100 may communicate with one or more of the other components of the IntelliVault 100 through either a wired or wireless connection.

The IntelliVault 100 comprises a communication interface 128. The communication interface 128 is configured to communicate over a network 140 to a non-user device 144. In some embodiments, the communication interface 128 may comprise one or more user interfaces (e.g., a keyboard, microphone, mouse, trackball, monitor, television, screen, touchscreen, smartphone, keypad, a physical security device, an electronic lock, laser, and/or any other device for receiving information from a user and/or for providing information to a user). The communication facilitated by the communication interface 128 may occur though a wired or wireless connection. Examples of wired connections may include ethernet, coaxial cable, fiber-optic cable, and combinations thereof, while examples of wireless communication may include Bluetooth®, communication over a cloud network, 4G, 5G, antennas for transmitting/receiving wireless signals, lasers, microwaves, GPS communication and combinations thereof.

The extractor 118 is configured to extract any biometric information associated with the user. For instance, the user may wish to store a fingerprint scan in the IntelliVault 100. The IntelliVault 100 may then access the extractor 118. The extractor 118 may then extract the biometric information associated with the fingerprint scan from the user. In some embodiments, the extractor 118 may access further user device functionality to capture the biometric information. For example, the extractor 118 may access or comprise a fingerprint scanner, camera, iris scanner, facial detection device, microphone, and/or any other capture method coupled with the user device to facilitate appropriate capture of one or more types of biometric information. In some embodiments, the user may access the extractor 118 to save multiple combinations of templates in the IntelliVault 100. The combinations of templates may depend on, for example, the set level of usability and security associated with the IntelliVault 100 and discussed in more detail later. In some embodiments, the templates may vary depending on the level of value associated with the corresponding transaction. For example, a bank account transfer may be deemed more valuable to the user than accessing a smart TV, and when extracting biometric modalities to use in template construction for the bank account transfer, may cause the IntelliVault 100 to combine the multiple instances of the captured biometric differently with other biometric captures to generate multiple combinations of templates using different portions of the biometric information captured by the extractor 118 to create different combinations of templates to secure the transaction (i.e., to verify the user).

The IntelliVault 100 may make use of a verifier 117. The verifier 117 may be configured to pre-filter any extracted information to determine the authenticity of the captured information. For instance, the verifier 117 may utilize a pre-face filtering module (e.g., a filtration algorithm implemented by a processor) capable of detecting non-face scans, such as when a mask is being worn by the user. In this instance, the verifier 117 may omit the storage of the captured information. As another example, the verifier 117 may be configured to detect silicon fingerprinting, and may be able to determine when the user is attempting to enter fingerprints of an individual who is not the user. Furthermore, the verifier 117 may comprise a quality module (e.g., a quality algorithm implemented by a processor), which may be capable of determining the quality associated with extracted modalities and information. The detection systems of the verifier 117 are not particularly limiting and may comprise additional detection modules and/or combinations thereof.

The user may additionally wish to add non-biometric information to the IntelliVault 100. The extractor 118 may provide the user with a method to enter the information. For instance, the user may wish to enter a personal identification number (PIN) or a password to the IntelliVault 100. The extractor 118 may provide the user with an interface (e.g., a user interface) to enter the PIN and/or password or any other information.

The extractor 118 may communicate the extracted biometric information (or optionally additional other information) to a database 107. The database 107 may be configured to accept digital information from any of the aspects of the IntelliVault 100. The database 107 may comprise an internal processor and instruction sets programmed to receive instructions and provide data stored thereon. The database 107 may be configured to store data associated with one or more types of biometric modalities, or combinations thereof.

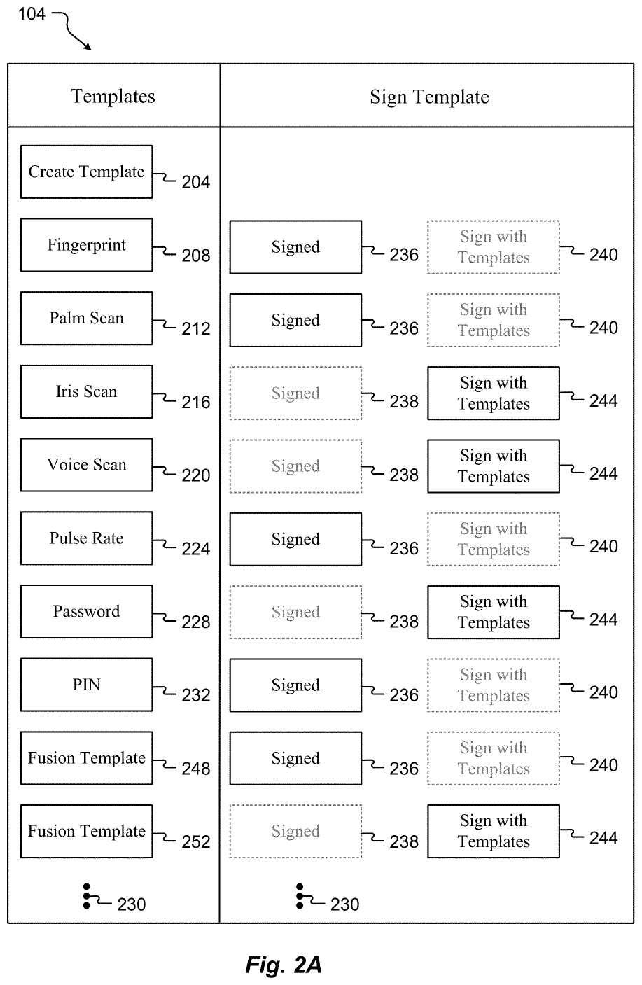

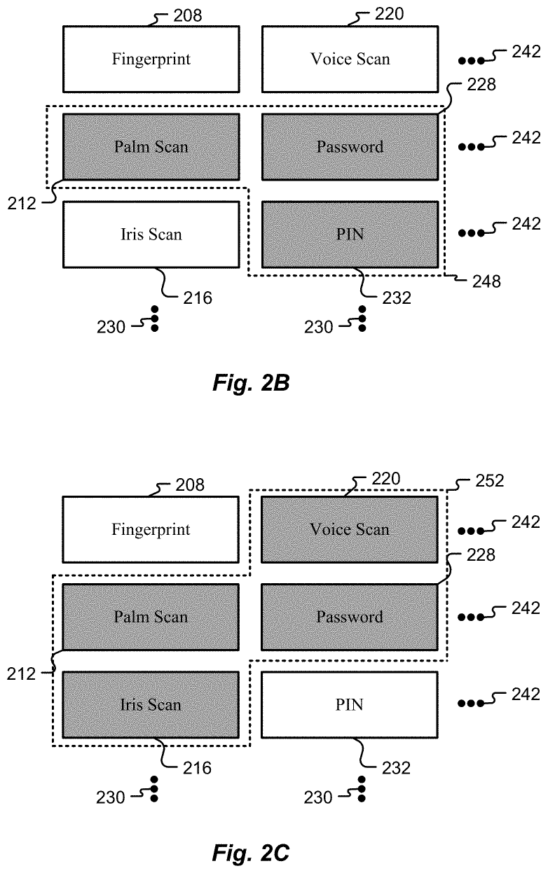

The IntelliVault 100 may comprise or be a repository 102 containing one or more templates 104. The template 104 may be configured to accept recorded modalities from the user and display a current list of the templates created from the recorded modalities. The entered modalities are not particularly limiting, and the user may enter biometric information (e.g., fingerprint, iris scan, face scan, pulse rate, palm scan, voice scan, blood pressure, hand vein pattern scan, ear scan, signature scan, etc.), biographical information (e.g. a password, a user PIN, a street address, a birth date, a phone number, a business name, etc.), behavioral data, metadata associated with the modalities, and/or any combination thereof. Once the templates are constructed, they may be stored in the database 107. In some embodiments, the templates may be permanently stored, temporarily stored, and/or instantaneously (i.e., virtually) be stored. Additionally or alternatively, the biometric and/or non-biometric data may be stored permanently, temporarily, and/or instantaneously. As illustrated in FIG. 2A, a user interface for the templates 104 may permit the user to sign their modalities, as well as view signed templates. In some embodiments, the one or more templates 104 may comprise multiple combinations of the same template depending on, for example, the level of security and/or usability of the IntelliVault 100 and/or the value the user places in the transactions using the templates. For example, a valuable transaction (e.g., opening a bank account) may use not only a higher number of biometric modalities in the template, but may use multiple combinations of the same template (e.g., a template comprising a facial scan and a voice scan may be used multiple times, but each time the template is used, the template combination uses different data associated with the facial scan and the voice scan).

For example, the user may choose to create a template by selecting the create template 204 button. Upon selection of the create template 204 button, the templates 104 may signal the extractor 118 to extract any biometric information the user wishes to store in the IntelliVault 100. As previously noted, in some embodiments, the user may choose to enter information in the form of non-biometric information. For instance, the user may desire to enter a personal identification number (PIN). In some embodiments, the extractor 118 may present the user with the choice between entering biometric information and non-biometric information. In one embodiment, once the user selects non-biometric information, the templates 104 may present the user with an interface to enter the non-biometric information. In some embodiments, the templates 104 may present pre-programmed choices from which the user may choose. For instance, the templates 104 may present the user with options such as “enter a new password”, “enter a new PIN”, and/or “enter a new mailing address”. The options presented to the user by the templates 104 are not limiting, and any form of non-biometric information choice may be presented to the user.

Once the user has entered any information the user wishes to store in the IntelliVault 100, the templates 104 may prompt the user to sign the new template with a pre-existing template. Signing the captured information to construct a new template amounts to using one or more previous templates to digitally sign the new information to create a new template. Referring to FIG. 2A, the templates 104 may present the user with a list of the current templates entered, as well as the signing status thereof. The user may enter, for example, a fingerprint 208, a palm scan 212, an iris scan 216, a voice scan 220, a pulse rate 224, a password 228, and/or a PIN 232. Moreover, the user may have a plurality of fusion templates, which may be formed from more than one template and/or fusion template. As previously noted, some templates may comprise biometric information, while some templates may be non-biometric information. In some embodiments, the templates may be formed from only biometric information, only non-biometric information, or a combination of biometric information and non-biometric information. Examples of non-biometric information may include, but are in no way limited to, text, one or more images (e.g., images without biometric information), PINs, passwords, phrases, combinations thereof, and/or any other form of digital information.

In some embodiments, some templates may remain unsigned until the user desires to implement the unsigned templates. For instance, the iris scan 216, the voice scan 220, and the password 228 may not be signed, as denoted by gray text and gray broken lines of a signed indicator 238. When the user wishes to sign any of the unsigned templates, the user may be presented with a method of signing the template. For example, to sign for the iris scan 216, the user may select the sign with templates button 244. Upon selection of the sign with templates button 244, the templates 104 may present the user with a list of pre-existing templates that have already been signed. The pre-existing templates that have already been signed may be indicated with a signed indicator 236, as well as gray text and gray broken lines of the sign with templates button 240. The user may choose one or more of the pre-existing and signed templates with which the user may sign for the iris scan 216. For instance, the user may elect to use the fingerprint 208 and the PIN 232 to sign for the iris scan 216. Once the user selects the fingerprint 208 and the PIN 232, the templates 104 may communicate to the signing manager 116 to complete the signing process. In this example, the signing manager 116 may prompt access a biometric scanner in the user device and prompt the user to scan the fingerprint associated with the fingerprint 208. The signing manager 116 may then prompt the user to enter the PIN number associated with PIN 232. Once the signing manager 116 has received the required information from the user, the signing manager 116 may verify the required information by comparing it to pre-existing palm scan 212 and the PIN 232 information stored in the database 107. Upon verification, the signing manager 116 may digitally sign the iris scan 216 using the palm scan 212 and the PIN 232, and may then communicate to the templates 104 that the iris scan 216 has been signed. Upon communication from the signing manager 116 to the templates 104 that the iris scan 216 has been signed, the templates 104 may indicate to the user through an interface that the signing of the iris scan 216 has been completed. The templates 104 may do this by changing the gray text and gray broken lines of the signed indicator 238 to the signed indicator 236, as well as change the sign with templates button 244 to the sign with templates button 240, which has gray text and gray broken lines indicating that the iris scan 216 no longer requires a signature. In some embodiments, the signing manager 116 may access the database 107 and extract the pre-existing palm scan 212 and the PIN 232 to digitally sign the iris scan 216, and may not require the user to input a new palm scan 212 and PIN 232.

The IntelliVault 100 may permit the user to construct fusion templates from one or more templates. For instance, the user may construct new templates using any combinatorial logic of the pre-existing or already-entered templates. Examples of such combinations may be viewed in FIGS. 2B-2C. As shown in FIG. 2B, the user may create a fusion template 248 using a combination of the palm scan 212, the password 228, and the PIN 232. Hence, the fusion template 248 may be a combination of the data associated with the palm scan 212, the password 228, and the PIN 232. In some embodiments, the IntelliVault 100 may randomly select data associated with the palm scan 212, the password 228, and the PIN 232 and structure the fusion template 248 data therefrom. Additionally or alternatively, the user may create a fusion template 252 using data associated with the palm scan 212, the iris scan 216, the voice scan 220, and the password 228, as noted in FIG. 2C. The IntelliVault 100 may take data from the palm scan 212, the iris scan 216, the voice scan 220, and the password 228 to construct the fusion template 252. The views of FIGS. 2B-2C are not particularly limiting. For instance, the templates may be organized in any order or combination. Furthermore, additional templates may be present, as indicated by ellipses 242, 230.

The data chosen in creating the fusion template 252 may be different than the data chosen to form the fusion template 248. For instance, while the palm scan 212 was used in the creation of both the fusion templates 248, 252, the data taken from the palm scan 212 when creating the fusion template 248 may not necessarily be the same data as the data taken when creating fusion template 252. Additionally or alternatively, the same data from the modalities may be taken when creating the fusion templates 248, 252, but may be organized in a different manner. For instance, the data associated with the password 228 may be taken for both the fusion templates 248, 252, but the data may be stored differently in the fusion template 248 than in the fusion template 252. In the fusion template 248, for example, the data associated with the password 228 may be combined with data associated with the palm scan 212, while in the fusion template 252 the data associated with the password 228 may not have been combined with the data associated with the palm scan 212. In some embodiments, the data associated with one or more templates may be combined with data associated with one or more templates to create new templates.

Some non-limiting examples of possible combinations include a logical combination, a mathematical combination (e.g., additive, multiplicative, etc.), an image/graphical combination, a pictorial combination, a partial combination, a multilayer combination, a random combination, a filtered combination, a nonlinear combination, and/or combinations thereof. The combination of the templates is in no way limiting, and any technique capable of combining data may be used. In some embodiments, one or more templates may be used as a filter for one or more other templates. For example, a first template may be a collection of numbers or other data, which may be used as a filter or projection to project, change, manipulate, scale, or otherwise obfuscate the underlying information of a second template. Moreover, any number of templates may be combined using any data combination technique in any order. A non-limiting example may be to form the digital information associated with a modality into a matrix, which is then broken into parts and reassembled with other parts of other modalities to form a new matrix that is a combination of portions of matrices associated with the other modalities. Another non-limiting example may involve utilizing a mathematical projection into a feature space. For example, the mathematical projection may project a matrix containing biometric information from one or more of the modalities into one or more spaces (e.g., an orthogonal projection in Euclidean space). The mathematical projections may be carried out by one or more algorithms configured to perform mathematical projections of one or more tensors (e.g., vectors, matrices, etc.) from a first vector space to a second vector space. In some embodiments, the combination method may be independent of the modalities selected by the user. In other words, the modalities may be combined in any manner to form the fusion template. In some embodiments, the fusion template may be compressed (e.g., using a data compression algorithm) while still providing an increased level of security than a single biometric modality. For example, while the fusion template may be compressed, the compressed data may still comprise information about multiple biometric modalities, affording the fusion template greater security than using a single biometric modality. In some embodiments, the combination of the biometric modalities to form the fusion template may be random and may be randomly changed at various time intervals (e.g., daily, weekly, monthly, etc.) to add an additional level of security.

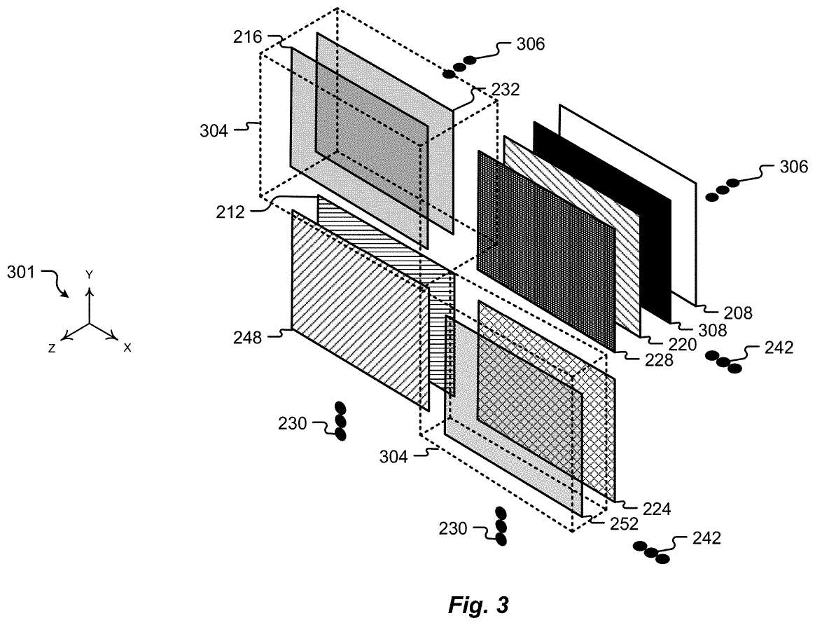

Additionally or alternatively, the fusion templates may further be formed from additional layers of other templates and/or fusion templates. Referring to FIG. 3, a fusion template 304 may be constructed by selecting data associated with multiple templates using additional dimensions to layer template data. Additionally or alternatively, the fusion templates may be constructed from previously existing fusion templates. For example, the fusion template 304 may be constructed from data associated with the iris scan 216, the PIN 232, and the fusion template 252. The templates may be layered or stacked in any order, and in any number of directions. For instance, the templates may be layered in an X-axis direction, a Y-axis direction, and a Z-axis direction, with reference to a coordinate system 301. The templates may extend beyond the number of templates shown in FIG. 3, as indicated by ellipses 230, 242, and 306. Not all groups of the templates may have the same number of templates. For instance, one group may appear in order along the negative Z-axis direction in the following order: the password 228, the voice scan 220, a template 308, and the fingerprint 208; while another group may only contain two templates, such as the palm scan 212 and the fusion template 248. The ordering of the templates along any axis is not particularly limiting, and any combinations of templates along any axis may be utilized. For instance, the fusion template 304 may choose two templates from the topmost layer (i.e., the iris scan 216 and the fusion template 252), while only choosing a single template from the next layer (i.e., the PIN 232). In some embodiments, the fusion template 304 may be formed from different templates in different layers.

Any fusion templates created by the user may be displayed by the templates 104. As seen in FIG. 2A, the fusion template 248 and the fusion template 252 may be shown to the user in a user interface, along with the other templates. In some embodiments, one or more of the fusion templates may remain unsigned until the user desires their use. For instance, the fusion template 248 may be already signed, as indicated by the signed indicator 236, as well as gray text and gray broken lines of the sign with templates button 240. The fusion template 252 may not be signed, as indicated by the gray text and gray broken lines of the signed indicator 238. To sign the fusion template 252, the user may select the sign with templates button 244. Upon selection of the sign with templates button 244, the user may be prompted by the templates 104 to select one or more pre-existing templates the user would like to use to digitally sign the fusion template 252. The pre-existing templates that have already been signed may be indicated with the signed indicator 236, as well as gray text and gray broken lines of the sign with templates button 240. The user may choose at least one of the pre-existing and signed template with which the user will sign for the fusion template 252. For instance, the user may elect to use the pulse rate 224 and the fusion template 248 to sign for the fusion template 252. Once the user selects the pulse rate 224 and the fusion template 248, the templates 104 may communicate to the signing manager 116 to access the database 107 for data associated with the pulse rate 224 and the fusion template 248. Upon receiving the requested data associated with the pulse rate 224 and the fusion template 248, the signing manager 116 may digitally sign the fusion template 252. The signing manager 116 may then communicate to the templates 104 that the fusion template 252 has been signed. Upon communication from the signing manager 116 to the templates 104 that the fusion template 252 has been signed, the templates 104 may indicate to the user through an interface that the signing of the fusion template 252 has been completed. The templates 104 may do this by changing the signed indicator with gray and broken lines 238 to the signed indicator 236, as well as change the sign with templates button 244 to the sign with templates button 240, which has gray text and gray broken lines indicating that the fusion template 252 no longer requires a signature.

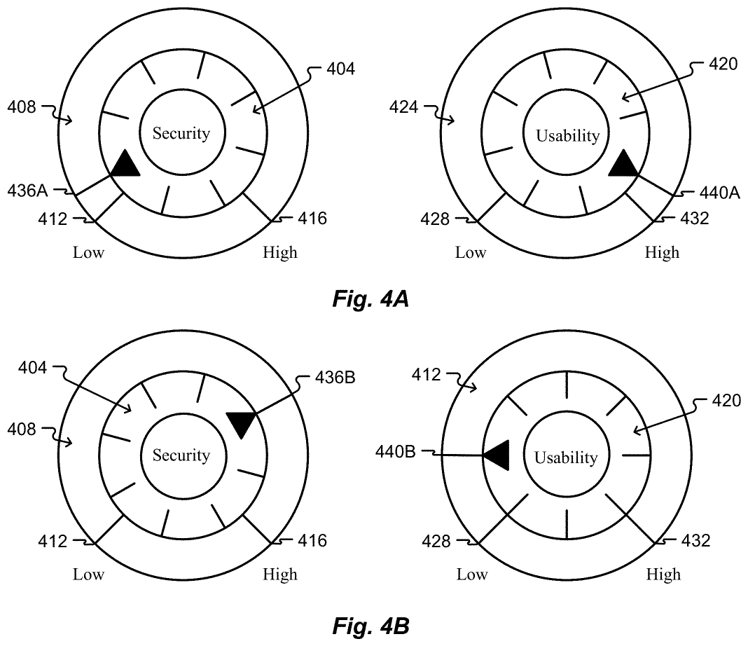

The user may be able to automatically adjust the IntelliVault 100 to a preferred level of security. In reference to FIGS. 4A-4B, the IntelliVault 100 may present the user with a security dial 404 and a usability dial 420. The security dial 404 may adjust the level of security of the IntelliVault 100, and may disable and/or enable various features of the IntelliVault 100 depending on the setting of the security dial 404. The security dial 404 may adjust a security strength 408. The security strength 408 may provide the user with a visual display of the level of security associated with the IntelliVault 100. In some embodiments, the security strength 408 may provide a range along which the security dial 404 may move. The security strength 408 may be discrete, continuous, and/or Boolean in nature, and may provide the security strength 408 either qualitatively and/or quantitatively. For instance, the security strength 408 may take a range of values from 0 to 100, with the security dial 404 capable of moving between integer values along the range of values from 0 to 100.

The security strength 408 may range from a low security 412 to a high security 416. In some embodiments, the user may adjust the security dial 404 by rotating the dial in a clockwise direction and/or a counter-clockwise direction. In one embodiment, the user may rotate the security dial 404 in the clockwise direction until the security dial 404 arrives at the high security 416. The high security 416 may be the highest security of the IntelliVault 100 available, and the security dial 404 may not rotate in the clockwise direction past the high security 416. The user may rotate the security dial 404 in the counter-clockwise direction until the security dial 404 arrives at the low security 412. The low security 412 may be the lowest security of the IntelliVault 100 available, and the security dial 404 may not rotate in the counter-clockwise direction past the low security 412.

The usability dial 420 may operate similarly to the security dial 404. The usability dial 420 may adjust the level of usability of the IntelliVault 100, and may disable and/or enable various features of the IntelliVault 100 that correspond to the usability of the IntelliVault 100. The usability dial 420 may adjust a usability level 424. The usability level 424 may provide the user with a visual display of the level of usability associated with the IntelliVault 100. In some embodiments, the usability level 424 may provide a range along which the usability dial 420 may move. The usability level 424 may be discrete, continuous, and/or Boolean in nature, and may provide the usability level 424 either qualitative and/or quantitative. For instance, the usability level 424 may take a discrete qualitative levels in a range comprising low, medium, and high, with the usability dial 424 capable of moving between the three levels.

The usability level 424 may range from a low usability level 428 to a high usability level 432. In some embodiments, the user may adjust the usability dial 424 by rotating the dial in a clockwise direction and/or a counter-clockwise direction. In one embodiment, the user may rotate the usability dial 424 in the clockwise direction until the usability dial 424 arrives at the high usability level 432. The high usability level 432 may be the highest usability level of the IntelliVault 100 available, and the usability dial 424 may not rotate in the clockwise direction past the high usability level 432. The user may rotate the usability dial 424 in the counter-clockwise direction until the usability dial 424 arrives at the low usability level 428. The low usability level 428 may be the lowest usability level of the IntelliVault 100 available, and the usability dial 424 may not rotate in the counter-clockwise direction past the low usability level 428.

The adjustment of the security level of the IntelliVault 100 is not limited to the embodiments shown in FIGS. 4A-4B, and may be presented in various forms. For example, the security level 408 may be presented to the user in the form of a slidable scale, permitting the user to slide a bar in two directions to raise or lower security. In some embodiments, the security level may be set manually by the user, wherein the IntelliVault 100 prompts the user to select a security level value from integers ranging between 0 and 100. Once the user selects an integer, the IntelliVault 100 may set the security level 408 to the selected integer.

The security dial 404 and the usability dial 420 may operate in a dependent nature upon one another; a higher security level may reduce the usability of the IntelliVault 100, while a higher usability may be implemented at the cost of higher security. The user may be able to adjust either the usability of the IntelliVault 100 or the security of the IntelliVault 100, with complementary movement in the other dial. In some embodiments, the IntelliVault 100 optimizes the usability level 424 with respect to the security strength 408 such that the user may set the security dial 404, and the IntelliVault 100 may optimize the usability features relative to the position of the security dial 404 on the security strength 408. The IntelliVault 100 may also optimize the security thereof relative to the usability level 424. For instance, the user may set the usability level 424 using the usability dial 420, and the IntelliVault 100 may optimize the security settings necessary based on the usability level 424. In some embodiments, the user may be able to adjust the security level 408 and/or the usability level 242 for each of the individual templates and/or usage rules for transactions, and/or combinations thereof.

In FIG. 4A, the security dial 404 may be set by the user to a first security value 436A. The first security value 436A may be closer to the low security 412 than to the high security 416. Accordingly, this first security value 436A may correspond to a lower security in the IntelliVault 100. Once the security dial 404 has been set to the first security value 436A, the complementary usability dial 420 may automatically adjust to indicate the relative level of usability of the IntelliVault 100. The usability dial 420 may terminate at a first usability value 440A. The first usability value 440A may be closer to the high usability level 432 than the low usability level 428. The first usability value 440A may indicate that the IntelliVault 100 has a high level of usability.

In some embodiments, the user may begin by first adjusting the usability dial 420 to the first usability level 440A. In this case, the adjustment of the usability dial 420 to the first usability level 440A may cause the security dial 404 to automatically adjust the relative level of security of IntelliVault 100, and may move to the first security level 436A.

The user may choose the security and usability levels shown in FIG. 4A when the user prefers convenience of the IntelliVault 100 to higher security. The user may be in an environment where there is no requirement for a high level of security, and/or where convenience is desirable. For example, the user may be at home and may wish to login to their account on their smart TV. The user may not wish to share a large amount of information with the smart TV, and may only wish to login using a small amount of authenticated data. In this instance, the user may wish to use the fingerprint 208 to login to the smart TV account. Since the IntelliVault 100 is set to a low security and high usability setting, the IntelliVault 100 may authenticate and send only data associated with the fingerprint 208 to the smart TV, allowing the user to login without the hassle of utilizing large amount of personal data or having the IntelliVault 100 limit the types of templates and/or usage rules as required by higher security embodiments.

FIG. 4B demonstrates a change to the security dial 404 and the usability dial 420. For instance, the user may decide to adjust the security of the IntelliVault 100 to a higher security value. The user may adjust the security dial 404 to a second security value 436B. Once the security dial 404 has been set to the second security value 424B, the usability dial 420 may automatically adjust to indicate the relative level of usability of the IntelliVault 100. The usability dial 420 may move to a second usability value 440B. The second usability value 440B may be closer to the low usability level 428 than the high usability level 432. The second usability value 440B may indicate that the IntelliVault 100 has a lower level of usability than the level of usability indicated in FIG. 4A. In some embodiments, the user may begin by first adjusting the usability dial 420 to the second usability level 440B. Accordingly, the adjustment of the usability level 424 by movement of the usability dial 420 to the second usability level 440B may cause the security dial 404 to automatically adjust the security strength 408 of the IntelliVault 100, and may move the second security level 440A.

The user may elect the security and usability levels indicated in FIG. 4B when the user requires security over usability. For instance, the user may be in an environment where security is paramount, and may desire to sacrifice usability to ensure security. The user may be in a foreign country, and may share a resemblance to general population of the foreign country. Accordingly, the user may have their IntelliVault 100 set to a higher security setting, as indicated by the second security level 436B. While in the foreign country, the user may wish to transfer money from their checking account to their savings account. In this instance, the IntelliVault 100 may ensure that transaction and authentication be based on a large number of templates, to ensure security in the transaction. In this case, the IntelliVault 100 be configured by the user to use not only a face scan, but also a fingerprint and a PIN to ensure the transaction and authentication are secure, and that only the user could authorize the transfer. The increased security may come as a tradeoff for lower usability, since the IntelliVault 100 may need to capture a fingerprint and a PIN in addition to a face scan in order to authenticate the user. As previously noted, the choice between the level of usability and the level of security may be at the discretion of the user. For instance, the user may choose to set the security to high to ensure that more sensitive or valuable transactions (e.g., bank account transfers) are secure, while lowering the security when conducting more routine or ordinary transactions (e.g., accessing a streaming service).

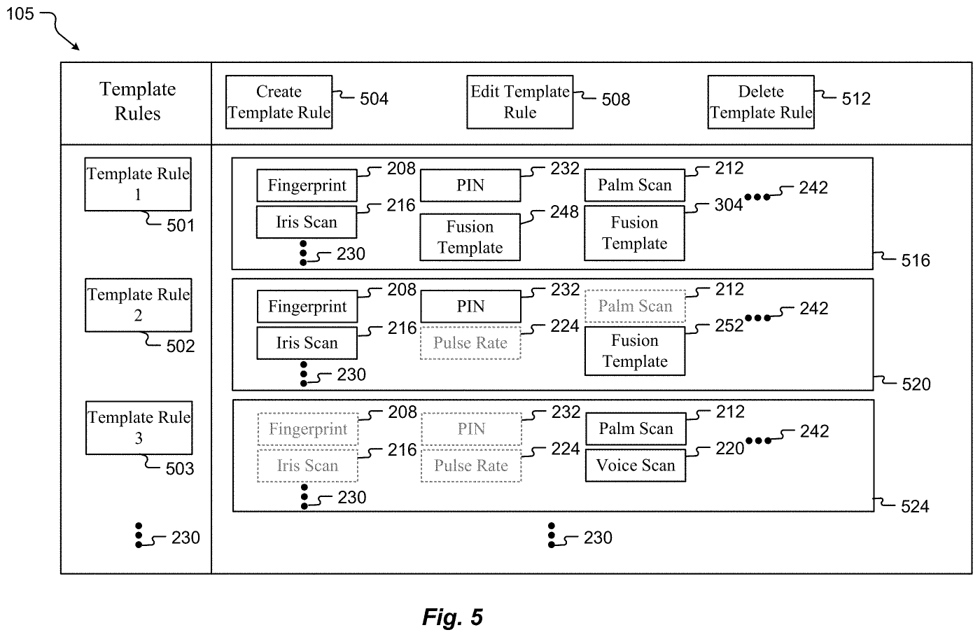

The IntelliVault 100 may further comprise template rules 105. The template rules 105 may be explained with reference to FIG. 5. Once the user has created one or more templates, the user may construct one or more template rules based on the one or more templates. In some embodiments, the template rules 105 may provide (e.g., via a user interface) the user with a create template rule button 504. Upon selection of the create template rule button 504, the user may be prompted to select from one or more templates to create a new template rule. Once the one or more templates have been chosen, the user may save the template rule. The template rules 105 may allow the user to view a list of template rules stored in the template rules 105, as well as the templates associated with each template rule. For instance, as shown in FIG. 5, a template rule 1 501, a template rule 2 502, and a template rule 3 503 may have been created by the user and may be presented to the user. More than three template rules may be created by the user, and may be shown to the user as well, as indicated by ellipsis 230. The user may also be presented with the templates used in the creation of each of the template rules. For example, the template rule 1 501 illustrates a plurality of templates used to construct the template rule 1 501, as noted by grouping 516: the fingerprint 208, the iris scan 216, the PIN 232, the fusion template 248, the palm scan 212, and the fusion template 304. Additionally or alternatively, the templates may extend beyond the six templates illustrated in FIG. 2, as noted by ellipses 230, 242.

Moreover, the orientation and use of the templates is not limited, and the orientation may be different than that shown in FIG. 5. For instance, the visual presentation to the user may be different depending on the embodiment. In some embodiments, the template rules 105 may present the user (e.g., via a user interface) with a list of the template rules and, upon selection of the template rule, the template rules 105 may present the user with all the templates associated therewith.

As noted previously, the template rule 1 501 may have six templates associated therewith. However, the template rule 2 502 may have only four templates associated therewith: the fingerprint 208, the iris scan 216, the PIN 232, and the fusion template 252, as shown in grouping 520. The pulse rate 224 and the palm scan 212 are not associated with the template rule 2 502, as indicated by the grey text and broken boarders shown therearound. In this instance, the user may have selected the fingerprint 208, the iris scan 216, the PIN 232, and the fusion template 252 as the only four templates to form the template rule 2 502.

The template rule 3 503 may have only two templates associated therewith: the palm scan 212 and the voice scan 220, as noted in a grouping 524. As shown in the grouping 524, four of the six shown templates may not be associated with the template rule 3 503: the fingerprint 208, the iris scan 216, the PIN 232, and the pulse rate 224, as noted by grey text and grey broken boarders therearound in the grouping 524.

The user may be able to modify, adjust, or otherwise change any template rule in the template rules 105. In some embodiments, the user may be presented with an edit template rule button 508. Upon selection of the edit template rule button 508, the user may be able to select a template from the list of template rules to modify the templates used in the template rule. The user may be able to select which templates to add and/or remove to update the template rule. The user may then save the template. In some embodiments, the edit template rule button 508 may prompt the user to select one or more template rules to edit, and permit the user to edit the one or more templates selected by the user simultaneously, without having to re-select the edit template rule button 508. Once the user has edited the one or more templates, the user may save the edits, and the template rules 105 may update the display to indicate the edits to the one or more template rules.

In some embodiments, the user may remove a template through the delete template rule button 512. The user may select the delete template rule button 512, and may be prompted to select one or more template rules to delete. Once the user has selected the desired template rules to be deleted, the user may press a delete button. The template rules 105 may then display a confirmation screen to the user to verify the deletion of the selected templates. In some embodiments, the template rules 105 may permit the user to select one or more template rules for deletion before displaying the confirmation screen. The template rules 105 may display the confirmation screen to the user before the user begins selecting the one or more template rules for deletion. In this instance, the user may have to press a save button to ensure the deletion is saved by the template rules 105.

In some embodiments, the adjustment of the security level of the IntelliVault 100 may change the availability of some features in the template rules 105. For instance, when the user has set the security dial 404 to the first security value 436A, the template rules 105 may present the user with the interface shown in FIG. 5. As previously mentioned, the first security value 436A may correspond to a low security level and a high usability level. Accordingly, the template rules 105 may allow the user full functionality and use of any template the user may desire in constructing, for example, template rule 1 501, template rule 2 502, and/or template rule 3 503.

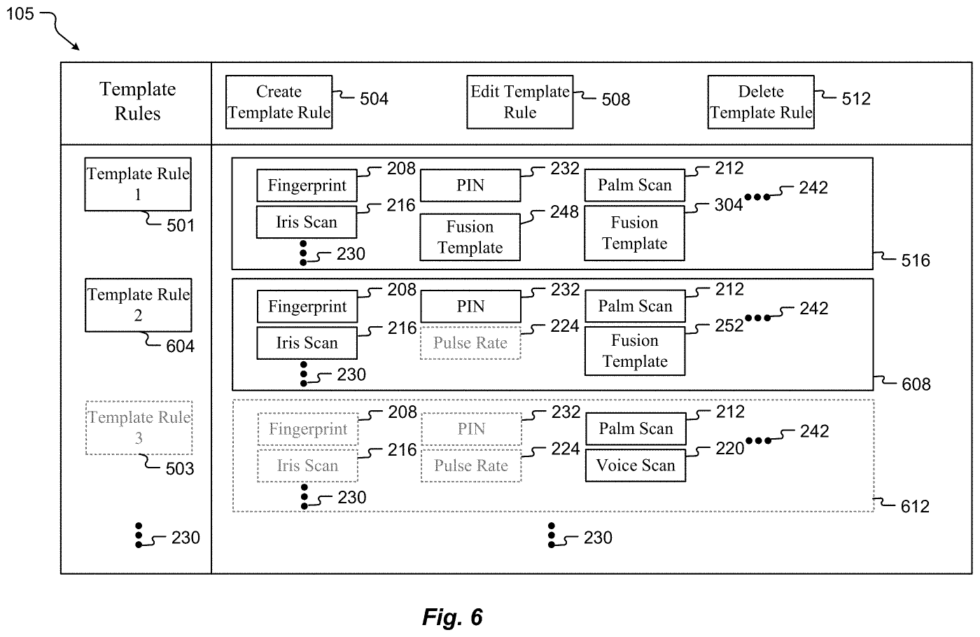

The user may then choose to set the security dial 404 to the second security value 436B. As noted above, the second security value 436B may correspond to a higher security level and lower usability level than when the security dial 404 is set to the first security value 436A. The resulting higher security level of the IntelliVault 100 may cause certain features to become unavailable to the user. For instance, as shown in FIG. 6, certain template rules may be altered or be partial or completely disabled when the security dial 404 is set to the second security value 436B. In the higher security level, the template rules 105 may indicate that one or more of the modalities may not be used in the template rule. For example, the IntelliVault 100 may determine that some or all of the template rules do not provide enough templates to ensure the set security level. For instance, the IntelliVault 100 may determine that the template rule 2 502 does not provide enough security based on the number of templates currently active in the template rule 2 502. In some embodiments, the IntelliVault 100 may then signal the template rules 105 to prompt the user to add additional modalities to the template rule 2 502 to increase security. The user may then add the palm scan 212 to the existing modalities and/or templates, as noted by grouping 608. This may form template rule 2 604, which includes the palm scan 212 that was previously not used in the template rule 2 502.

In some embodiments, once the security dial 404 is set to the second security value 436B, the IntelliVault 100 may disable one or more template rules in the template rules 105. For instance, the IntelliVault 100 may determine that the template rule 3 503 does not provide enough security. The IntelliVault 100 may then change the template rule 3 503 to template rule 3 612, which may not be available for use by the user, as denoted by the gray broken lines of grouping 612. The IntelliVault 100 may then indicate to the user that template rule 3 503 is not secure enough for the second security value 436B, and has been disabled. The IntelliVault 100 may permit the user to adjust template rule 3 503 to a sufficient number of templates to meet the security requirements of the second security value 436B.

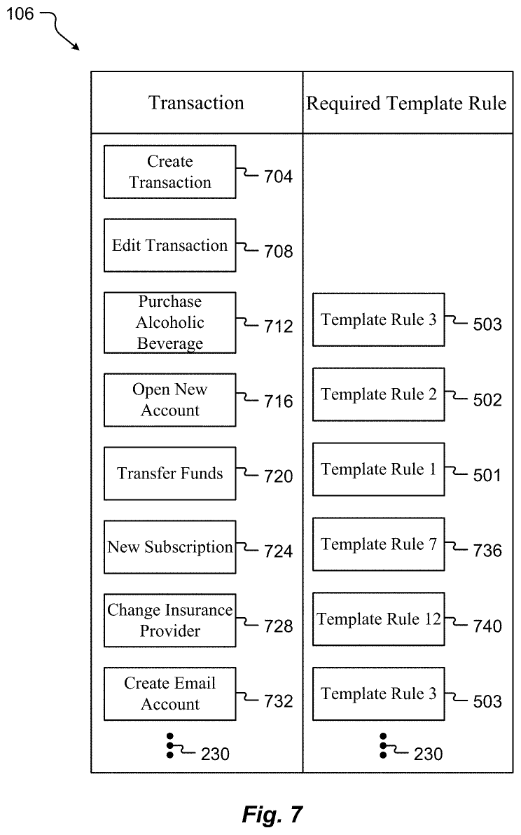

The IntelliVault 100 may further comprise a usage rules 106. The usage rules 106 may provide the user with the ability to define one or more transactions and the required template rule associated with the one or more transactions. The user may begin by creating a new transaction using the create transaction button 704. The usage rules 106 may then prompt the user to enter a description or phrase associated with the transaction. In some embodiments, the usage rules 106 may provide the user with a list of pre-programmed words and/or phrases for popular, useful, and/or frequently occurring transactions. After the user enters the description or phrase, or elects a pre-programmed word or phrase, the usage rules 106 may prompt the user to select a template rule to associate with the transaction. For example, as illustrated in FIG. 7, the usage rules 106 may present the user with a plurality of transactions and template rules therefor.

Various template rules may be associated with various transactions. For example, the transaction associated with purchasing an alcoholic beverage may be indicated to the user as a purchase alcoholic beverage transaction 712, with associated template rule 3 503. Further transactions created by the user may be presented to the user by the usage rules 106. For instance, the user may create a new account transaction 716, such as opening a new checking account at a local bank. The user may assign template rule 2 502 to the create a new account transaction 716. The user may create a transfer funds transaction 720, such as a transfer of funds from the user's checking account to the user's savings account, to which the user may assign template rule 1 501. The user may define a new subscription transaction 724, which the user may utilize when applying for or subscribing to new subscriptions, such as a newspaper subscription. The user may assign a template rule 7 736 to this transaction. Furthermore, the user may wish to change an insurance provider, and may create a change insurance provider transaction 728 and assign template rule 12 740 thereto. The user may define a transaction for generating and signing into a new email account, a create email account transaction 732, to which the user may assign template rule 3 503. The list of transactions and their associated template rules is not particularly limited, and additional transactions may be shown to the user by the usage rules 106, as noted by ellipsis 230.

The purchase alcoholic beverage transaction 712 may be associated with template rule 3 503 as noted above. In this instance, the template rule 3 503 may only utilize two templates (i.e. the palm scan 212 and the voice scan 220). Accordingly, template rule 3 503 may have a relatively lower security threshold than template rule 2 502 or template rule 1 501, which utilize a greater number of templates. However, template rule 3 503 only requires two modalities in order to complete the transaction, providing the user with the option to share less personal information in order to complete the transaction. The user may desire that more mundane or lower-risk transactions be secured with fewer templates, resulting in the sharing of less user information, and accordingly may select template rule 3 503 for the simple and informationally cheap transaction of purchasing an alcoholic beverage.

In contrast to purchasing an alcoholic beverage, the user may prefer that high-risk or life-altering transactions be more secure. For instance, the transfer funds transaction 720 may utilize template rule 1 501. As shown in FIG. 5, the template rule 1 501 may incorporate at least six templates and/or fusion templates of multiple templates. In this instance, the use of template rule 1 501 affords the user greater security when completing transactions. In this instance, the user may desire that a greater amount of information is used in authenticating the transaction, which may deter or limit the ability of bad actors from duplicating the transaction.

In some embodiments, the adjustment of the security strength 408 and/or the usability level 424 of the IntelliVault 100 may change the availability and/or implementation of some features in the usage rules 106. For instance, when the user has set the security dial 404 to the first security value 436A, the usage rules 106 may present the user with the interface shown in FIG. 7. As previously mentioned, the first security value 436A may correspond to a low security level and a high usability level. Accordingly, the template rules 106 may allow the user full functionality in assigning any template to any transaction the user may desire in constructing. For example, the user may desire to assign any of the template rule 1 501, the template rule 2 502, and the template rule 3 503 to any one of the transactions noted in FIG. 7 and/or any other transaction.

The user may then choose to set the security dial 404 to the second security value 436B. The second security value 436B may correspond to a higher security level and lower usability level than when the security dial 404 is set to the first security value 436A. The resulting higher security level of the IntelliVault 100 may cause certain features to become unavailable to the user. For instance, the IntelliVault 100 may filter the usage rules and determine that the template rule 3 503 is no longer sufficient to meet the security level associated with the second security value 436B. In some embodiments, the IntelliVault 100 may determine that the template rule 3 503 is sufficient in some usage rules, but insufficient in other usage rules. The usage rules 106 may reflect this as shown with the gray text and gray broken boarder of template rule 3 503 associated with the create email account transaction 732, but with a normal template rule 3 503 associated with the purchase alcoholic beverage transaction 712. This may indicate that the template rule 3 503 presents sufficient security when the transaction is purchasing an alcoholic beverage, but not sufficient enough to carry out a transaction involving an email account.

In some embodiments, the second security value 436B adjustment may cause the IntelliVault 100 to modify one or more of the usage rules in the usage rules 106. For instance, the IntelliVault 100 may prompt the usage rules 106 to change the template rule 2 502 associated with the create a new account transaction 716 to the template rule 2 604. As previously noted, the template rule 2 604 is similar to the template rule 2 502 but containing additional modalities in the form of at least the palm scan 212. Hence, the IntelliVault 100 may be capable of adjusting the usage rules based on the user's desired level of security.

The IntelliVault 100 may further comprise transaction credentials 108. The transaction credentials 108 may be or comprise any data packets required for transmission to a third party when the user wishes to conduct a transaction. For instance, in the event a user wishes to conduct a transaction, the transaction identifier 132 may identify the user's desire to conduct the transaction. For example, the transaction identifier 132 may identify that the user wishes to login to their smart TV, and may communicate the transaction to the transaction manager 112. The transaction manager 112 may then access the database 107 to retrieve the usage rules associated with the login to the smart TV. In the instant case, the transaction manager 112 may determine that the transaction is associated with the template rule 7 736. The template rule 7 736 may have only a two templates associated with it: the palm scan 212 and the PIN 232. The transaction manager 112 may determine that the palm scan 212 and the PIN 232 are associated with the template rule 7 736, and may then prompt the transaction credentials module 108 to access the database 107 and package the required information associated with the palm scan 212 and the PIN 232 in order to complete the transaction. In the current example, the transaction credentials module 108 may receive instructions from the transaction manager 112 to determine the precise digital information and structure thereof required by the smart TV in order to authenticate the transaction. Once the transaction credentials module 108 has packaged the data, the transaction credentials module 108 may send the packaged data to the transaction manager 112. The transaction manager 112 may then access a secret token that is unique to the user device. Upon accessing the secret token, the transaction manager 112 may use the secret token to digitally sign the packaged data. While some embodiments may utilize a secret token, the use of a secret token is no way limiting, and other options are available. One non-limiting example includes using cryptographic keys. Any method of digital verification may be used, so long as the digital verification provides an indication that the packaged data is authenticated and from the user device.

The secret token may provide a form of authentication to the receiving non-user device 144 (e.g. the smart TV) that the packaged data is signed and is therefore authentic and from the IntelliVault 100 of the user device. The transaction manager 112 may then send the signed packaged data to the communication interface 128, which may send the signed packaged data through either a wired connection or wirelessly to the smart TV.

The IntelliVault 100 or similar systems may be used, for example, to carry out one or more aspects of any of the methods 900, 1000, 1100, and/or 1220 described herein. The IntelliVault 100 or similar systems may also be used for other purposes.

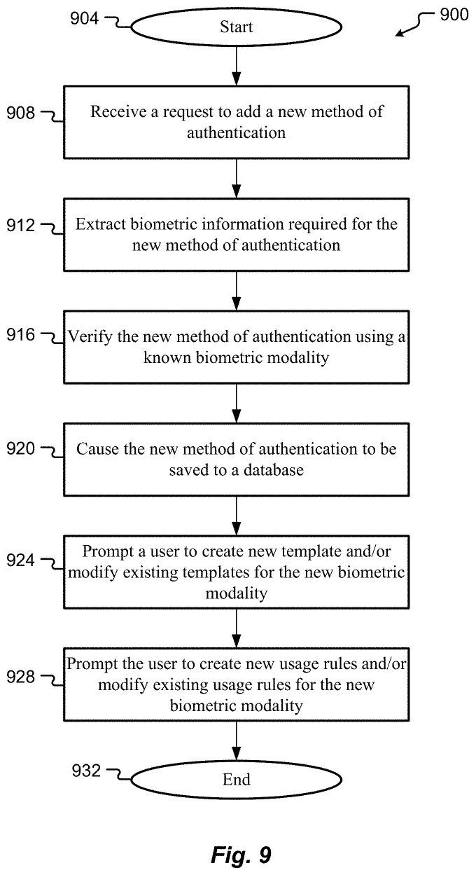

The flowchart of FIG. 9 depicts a method 900 in accordance with embodiments of the present disclosure. In more detail, FIG. 9 illustrates using the IntelliVault 100 to add, sign, and provision methods of authentication.

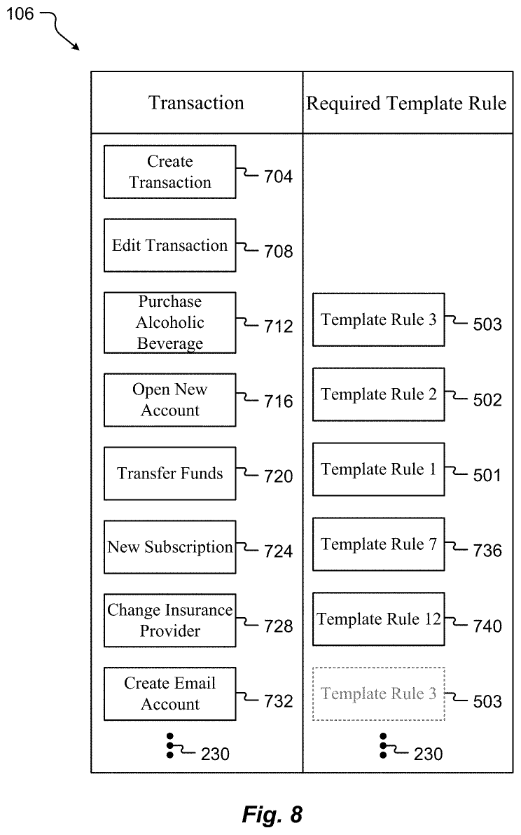

The method 900 (and/or one or more steps thereof) may be carried out or otherwise performed, for example, by at least one processor. The at least one processor may be the same as or similar to the processor(s) 120 described above. The at least one processor may be part of an IntelliVault (e.g., an IntelliVault 100) or part of one or more components thereof. A processor other than any processor described herein may also be used to execute the method 900. The at least one processor described herein may perform the method 900 by executing instructions stored in a memory (e.g., a memory 124). The instructions may correspond to one or more steps of the method 900 described below. The instructions may cause the processor to execute one or more algorithms to carry out the method 900 (and/or one or more steps thereof). While a general order for the steps of the method 900 is shown in FIG. 9, the method 900 can include more or fewer steps or can arrange the order of the steps differently than those shown in FIG. 9. Generally, the method 900 starts at step 904 and ends at step 932. Alternatively, the steps discussed with respect to FIG. 9 may be implemented by the various elements of the system(s) in FIGS. 1-8. Hereinafter, the method 900 shall be explained with reference to the systems, components, assemblies, devices, user interfaces, environments, software, etc. described in conjunction with FIGS. 1-8.

The method 900 comprises receiving a request to add a new method of authentication (step 908). In some embodiments, the user may select a new method of authentication (e.g., via a user interface). This may include a new biometric modality or a new non-biometric modality, or a combination thereof. The user may input into the user device the type of new modality the user wishes to enter. For example, the user may wish to enter the fingerprint 208 into the IntelliVault 100.

The method 900 also comprises extracting biometric information required for the new method of authentication (step 912). The extractor 118, through the processor 120, extracts the biometric information associated with the fingerprint 208. In some embodiments, the extractor 118 may interact with a fingerprint scanner associated with the user device. The extractor 118 may utilize the fingerprint scanner by prompting the user to place the finger on the scanner and scan the user's finger to obtain the fingerprint 208. In some embodiments, the extractor 118 may then implement the verifier 117 to verify the fingerprint 208.

The method 900 also comprises verifying the new method of authentication using a known biometric modality (step 916). The method 900 activates the signing manager 116 to complete the signing of the new information with the known (e.g., pre-existing) biometric modality. Continuing this example, the user may already have the iris scan 216 and the password 228 stored in the IntelliVault 100. In some embodiments, the signing manager 116 may access a biometric scanner in the user device and prompt the user for an iris scan. The signing manager 116 may also prompt the user to enter the password. Upon entering of the iris scan and the password, the signing manager 116 may then access the database 107 to verify the iris scan and the password by comparing it to the previously entered iris scan 216 and password 228. In some embodiments, the comparison may be based on a threshold, which may indicate a level of sufficient similarity between the two. For instance, the threshold may set a level above which the modality (e.g., the captured iris scan) may be sufficiently similar to the stored modality (e.g., the iris scan 216) to be treated as the same. Similarly, a value below the threshold level may indicate that the two modalities are not similar enough to be treated as the same (e.g., the iris scans may be from different people).

The method 900 also comprises causing the new method of authentication to be saved to a database (step 920). For example, if the iris scan and password entered by the user match the iris scan 216 and the password 228, the signing manager 116 signs and stores the fingerprint 208 in the database 107.

The method 900 also comprises prompting a user to create a new template and/or modify existing templates for the new biometric modality (step 924). In at least one embodiment, the templates 104 may prompt (e.g., through the processor 120) the user to create a new template based on at least the fingerprint 208. For example, the user may wish to create a new template containing the fingerprint 208, the iris scan 216, and the password 228. The templates 104 may save the new template containing the fingerprint 208, the iris scan 216, and the password 228 in the database 107. Furthermore, the user may be prompted to modify existing templates to include the fingerprint 208. For instance, the user may already have a template containing the iris scan 216, the PIN 232, and the voice scan 220, and may want to add the fingerprint 208 to the template. The user may then add the fingerprint 208 to the template and the templates 104 may update the template to reflect the addition of the fingerprint 208 to the template.

The method 900 also comprises prompting the user to create new usage rules and/or modify existing usage rules for the new biometric modality (step 928). The processor 120 prompts the user to add a new usage rule for the fingerprint 208 (i.e., the new biometric modality added to the database 107 in the step 920). The method 900 may access the usage rules 106 to permit the user to add new usage rules for the fingerprint 208 (e.g., via a user interface). For instance, the user may wish to use the fingerprint 208, along with the PIN 232, to construct a usage rule directed toward purchasing an alcoholic beverage. In some embodiments, the user may construct a usage rule directly using the fingerprint 208, or additionally or alternatively may utilize a fusion template including the fingerprint 208 in constructing the usage rule. Additionally or alternatively, the user may be prompted to modify existing usage rules to include templates related to the fingerprint 208. In some embodiments, the user may either directly utilize the fingerprint 208 or a fusion template containing the fingerprint 208 to update the usage rules. For example, the user may have two pre-existing rules: a usage rule for opening a bank account and a usage rule for creating a new email account. The user may update the rule for creating a new bank account by introducing the fingerprint 208 as a template for use in the template rule. Once the fingerprint 208 has been added to the template rule for opening a new bank account, future uses of the template rule for creating a new bank account may implement the fingerprint 208 in the completion of the transaction. Additionally or alternatively, the user may update the usage rule for creating a new email account by adding a fusion template containing the fingerprint 208. Accordingly, in future uses of the usage rule for creating a new email account, the fusion template containing the fingerprint 208 may be utilized in completing the transaction.

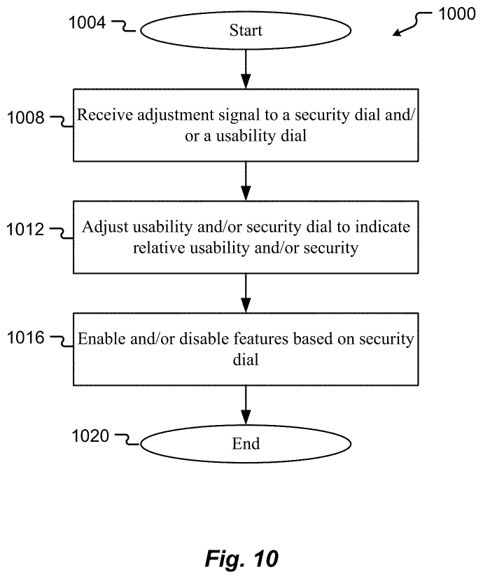

The flowchart of FIG. 10 depicts a method 1000 in accordance with embodiments of the present disclosure. In more detail, FIG. 10 illustrates the user setting a desired level of security and/or usability associated with the IntelliVault 100.

The method 1000 (and/or one or more steps thereof) may be carried out or otherwise performed, for example, by at least one processor. The at least one processor may be the same as or similar to the processor(s) 120 described above. The at least one processor may be part of an IntelliVault (e.g., an IntelliVault 100) or part of one or more components thereof. A processor other than any processor described herein may also be used to execute the method 1000. The at least one processor described herein may perform the method 1000 by executing instructions stored in a memory (e.g., a memory 124). The instructions may correspond to one or more steps of the method 1000 described below. The instructions may cause the processor to execute one or more algorithms to carry out the method 1000 (and/or one or more steps thereof). While a general order for the steps of the method 1000 is shown in FIG. 10, the method 1000 can include more or fewer steps or can arrange the order of the steps differently than those shown in FIG. 10. Generally, the method 1000 starts at step 1004 and ends at step 1020. Alternatively, the steps discussed with respect to FIG. 10 may be implemented by the various elements of the system(s) in FIGS. 1-8. Hereinafter, the method 1000 shall be explained with reference to the systems, components, assemblies, devices, user interfaces, environments, software, etc. described in conjunction with FIGS. 1-8.

The method 1000 comprises receiving an adjustment signal to a security dial and/or a usability dial (step 1008). The adjustment signal may be received from a user of the IntelliVault 100 (e.g., via a user interface displaying the security dial 404 and/or the usability dial 420). The user may want to adjust the security and/or usability of the IntelliVault 100 and may be able to adjust the security and/or usability of the IntelliVault 100 through the use of the security dial 404 and/or the usability dial 420. The adjustment signal may change the security and/or usability of the IntelliVault 100. For example, the user may adjust the security dial 404 to a lower security when the user desires a lower security or is in an environment where security is not a concern to the user.

The method 1000 also comprises adjusting the usability and/or security dial to indicate relative usability and/or security (step 1012). The adjustment is based on the adjustment of the security dial 404 and/or the usability dial 420 in the step 1008. In some embodiments, the IntelliVault 100 may appropriately adjust the complementary dial. For instance, if the user were to move the security dial 404 to a lower security level, the IntelliVault 100 may move the usability dial 420 to a higher usability level and display the higher usability level to the user, to indicate to the user that the resulting movement of the security dial 404 to a lower security has correspondingly raised the level of usability of the system. Additionally or alternatively, if the user moves the usability dial 420 to a higher usability level, the IntelliVault 100 may move the security dial 404 to a lower security level, and then may present this information to the user (e.g., via a user interface) to indicate that the increase in usability of the IntelliVault 100 may come at the cost of increased security.

The method 1000 also comprises enabling and/or disabling features based on the security dial (step 1016). The IntelliVault 100, through the processor 120, adjusts the features available to the user based on the security dial 404 and/or usability dial 420 set in the step 1012. For example, the movement of the security dial 404 to the lower security level may cause the IntelliVault 100 to unlock and/or lock one or more features, such as permitting the use of the template rule 3 503, which may have been locked in the higher security level. The template rule 3 503 may contain the palm scan 212 and the voice scan 220 and may therefore have been determined by the IntelliVault 100 to lack sufficient security for the higher security level. However, once the lower security level has been determined (such as by the steps 1008 and/or 1012), the IntelliVault 100 may unlock the use of the template rule 3 503 and/or any usage rules based thereon.

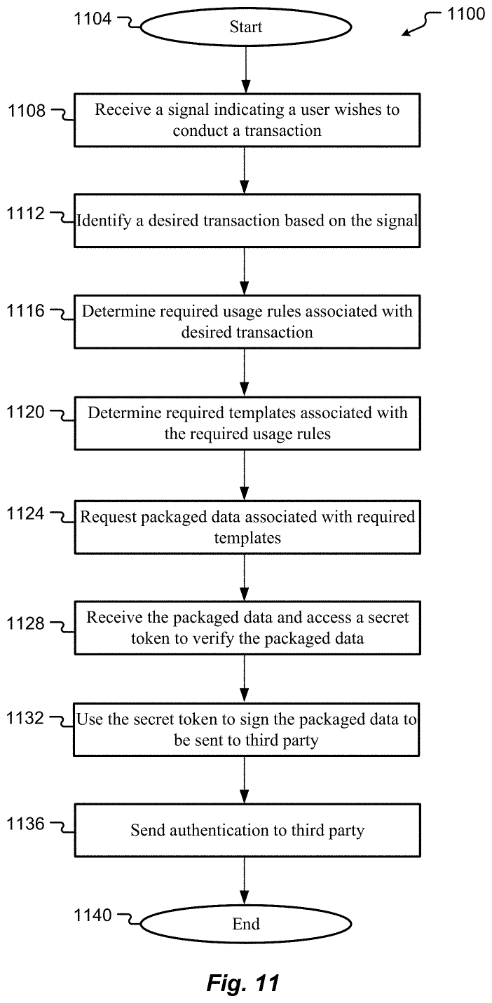

The flowchart of FIG. 11 depicts a method 1100 in accordance with embodiments of the present disclosure. In more detail, FIG. 11 illustrates using the IntelliVault 100 to conduct a transaction.

The method 1100 (and/or one or more steps thereof) may be carried out or otherwise performed, for example, by at least one processor. The at least one processor may be the same as or similar to the processor(s) 120 described above. The at least one processor may be part of an IntelliVault (e.g., an IntelliVault 100) or part of one or more components thereof. A processor other than any processor described herein may also be used to execute the method 1100. The at least one processor described herein may perform the method 1100 by executing instructions stored in a memory (e.g., a memory 124). The instructions may correspond to one or more steps of the method 1100 described below. The instructions may cause the processor to execute one or more algorithms to carry out the method 1100 (and/or one or more steps thereof). While a general order for the steps of the method 1100 is shown in FIG. 11, the method 1100 can include more or fewer steps or can arrange the order of the steps differently than those shown in FIG. 11. Generally, the method 1100 starts at step 1104 and ends at step 1140. Alternatively, the steps discussed with respect to FIG. 11 may be implemented by the various elements of the system(s) in FIGS. 1-8. Hereinafter, the method 1100 shall be explained with reference to the systems, components, assemblies, devices, user interfaces, environments, software, etc. described in conjunction with FIGS. 1-8.

The method 1100 comprises receiving a signal indicating a user wishes to conduct a transaction (step 1108). The user utilizes the IntelliVault 100 (and/or one or more components thereof) to conduct the transaction. In some embodiments, the transaction identifier 132 may identify the type of transaction the user wishes to conduct. For example, the user may wish to purchase an alcoholic beverage.

The method 1100 also comprises identifying a desired transaction based on the signal (step 1112). The transaction identifier 132 may identify the user's desire to purchase an alcoholic beverage at operation 1112 and may communicate the transaction to the transaction manager 112.

The method 1100 also comprises determining the required usage rules associated with the desired transaction (step 1116). The transaction manager 112 may access the database 107 to retrieve the usage rules associated with the purchase or transaction. In the case of the user's desire to purchase the alcoholic beverage, the transaction manager 112 may determine, through the processor 120, that the transaction is associated with template rule 3 503.

The method 1100 also comprises determining required templates associated with the required usage rules (step 1120). The transaction manager 112 may determine, through the processor 120, which templates are associated with the template rule 3 503. For instance, the template rule 3 503 may have the palm scan 212 and the voice scan 220 associated therewith. The transaction manager 112 may determine that both the palm scan 212 and the voice scan 220 are the only two templates associated with the template rule 3 503.

The method 1100 also comprises requesting packaged data associated with the required template. For example, the transaction manager 112 can access the transaction credentials module 108 to determine the data needed for authentication for the particular transaction, and request that the data be packaged (e.g., formatted in a computer-readable format) by, for example, a processor.

The method 1100 also comprises receiving the packaged data and accessing a secret token to verify the packaged data (step 1128). The transaction credentials module 108 may receive the request from the transaction manager 112 and may return the required information (e.g., the packaged data). The transaction credentials module 108 may, through the use of the processor 120, determine the exact digital information and digital structure thereof required to authenticate the transaction. For instance, the transaction credentials module 108 may determine which data structures associated with the palm scan 212 and the voice scan 220 are required by the third party to authenticate the transaction. The transaction credentials module 108 may then package the required digital information in an appropriate digital structure. The transaction manager 112 may then access a secret token unique to the user device in order to sign the packaged data.

The method 1100 also comprises using the secret token to sign the packaged data to be sent to a third party (step 1132). The transaction manager 112 may digitally sign (e.g. using a processor) the packaged data with the secret token, effectively authenticating the packaged data. This may provide a form of authentication to the receiving non-user device 144 that the packaged data is authenticated, and from the IntelliVault 100 of the user device.

The method 1100 also comprises sending the authentication to the third party (step 1136). The transaction manager may send an authenticated data set to a third party to purchase the alcoholic beverage. In some embodiments, the authenticated data to complete the transaction may be sent over the network 140 to the non-user device 144.

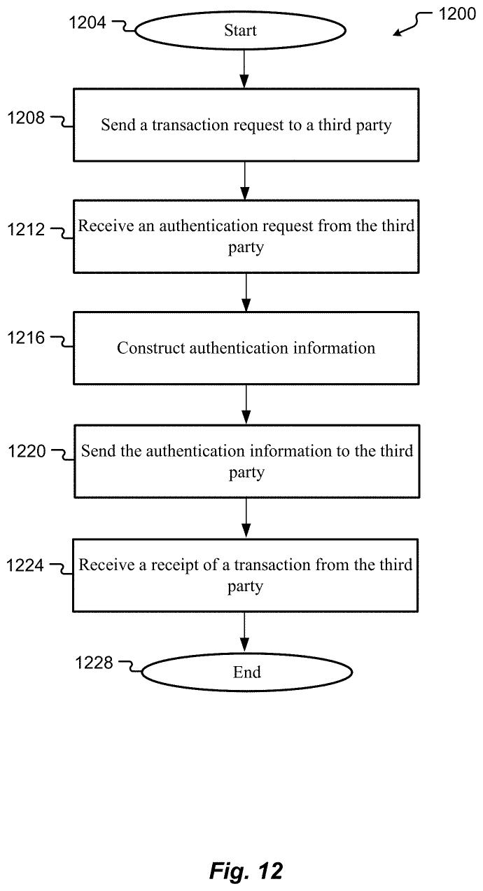

The flowchart of FIG. 12 depicts a method 1200 in accordance with embodiments of the present disclosure. In more detail, FIG. 12 illustrates a communication flow between a third party and the IntelliVault 100.

The method 1200 (and/or one or more steps thereof) may be carried out or otherwise performed, for example, by at least one processor. The at least one processor may be the same as or similar to the processor(s) 120 described above. The at least one processor may be part of an IntelliVault (e.g., an IntelliVault 100) or part of one or more components thereof. A processor other than any processor described herein may also be used to execute the method 1200. The at least one processor described herein may perform the method 1200 by executing instructions stored in a memory (e.g., a memory 124). The instructions may correspond to one or more steps of the method 1200 described below. The instructions may cause the processor to execute one or more algorithms to carry out the method 1200 (and/or one or more steps thereof). While a general order for the steps of the method 1200 is shown in FIG. 12, the method 1200 can include more or fewer steps or can arrange the order of the steps differently than those shown in FIG. 12. Generally, the method 1200 starts at step 1204 and ends at step 1228. The method 1200 can be executed as a set of computer-executable instructions encoded or stored on a computer readable medium and executed by the processor 120. Alternatively, the operations discussed with respect to FIG. 12 may be implemented by the various elements of the system(s) in FIGS. 1-8. Hereinafter, the method 1200 shall be explained with reference to the systems, components, assemblies, devices, user interfaces, environments, software, etc. described in conjunction with FIGS. 1-8.

The method 1200 comprises sending a transaction request to a third party (step 1208). In some embodiments, the user may request to conduct a transaction with a third party. For instance, the user may wish to move money from their checking account to their savings account. The IntelliVault 100 (and/or one or more components thereof) may utilize the communication module 128 over the network 140 to contact the bank and request the transaction.

The method 1200 also comprises receiving an authentication request from the third party (step 1212). In response to the sending the transaction request, the bank may issue a digital request for authentication over the network 140 to the communications module 128 in the IntelliVault 100. The communications module 128 may communicate the required authentication information to the transaction manager 112.

The method 1200 also comprises constructing authentication information (step 1216). The transaction manager 112 may proceed (e.g., using a processor) by compiling and digitally signing the required digital information for authentication (e.g., information required to be sent to the bank to authenticate the user). For example, the transaction manager 112 may obtain digital information related to one or more biometric modalities (e.g., the fingerprint 208, the iris scan 216, etc.) for sending to the third party. In some embodiments, authentication information may be or comprise one or more templates (e.g., templates 104) depending on, for example, the type of transaction, the security and/or usability levels of the IntelliVault 100, combinations thereof, and/or the like.

The method 1200 also comprises sending the authentication information to the third party (step 1220). The IntelliVault 100 may send, by way of the communications module 128, the required digital information for authentication over the network 140 to the bank. The third party may then complete the transaction based on the authentication information. For example, the bank may process the authentication information to verify that the user is authentic. The bank, having received the verification, may then transfer the funds.

The method 1200 also comprises receiving a receipt of a transaction from the third party (step 1224). In some embodiments, after the transaction has been completed, the third party may send a receipt of transaction over the network 140 to the IntelliVault 100. For example, the bank may send a receipt indicating that the funds were transferred from the user's checking account to the user's savings account. The receipt may contain additional or alternative information and/or metadata relating to the transaction. In some embodiments, the IntelliVault 100 may display the receipt to the user, providing the user with a confirmation that the transaction has been completed.

Any of the steps, functions, and operations discussed herein can be performed continuously and automatically.

The exemplary systems and methods of this disclosure have been described in relation to an IntelliVault. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Exemplary aspects include:

An IntelliVault device, comprising: a communication interface that facilitates communication between the IntelliVault device and a network; a processor coupled with the communication interface; and a computer-readable storage medium coupled with the processor and comprising instructions that are executable by the processor, wherein the instructions comprise: a templates module; a usage rules module; and an extraction module; wherein: the extraction module extracts, by a first extraction device, a first biometric modality associated with the user, the extraction module extracts, by the first extraction device, a second biometric modality associated with the user, and the template rules module creates a first fusion template by logically combining the first biometric modality and the second biometric modality.

Any one or more of the aspects further including that the usage rules module comprises a plurality of rules, wherein each usage rule of the plurality of rules is associated with a transaction, and wherein the transaction requires one or more fusion templates.

Any one or more of the aspects further including that the one or more fusion templates comprise the first fusion template and a second fusion template created by logically combining the first biometric modality, the second biometric modality, and a third biometric modality associated with the user, wherein the third biometric modality is extracted by the first extraction device of the extraction module.

Any one or more of the aspects further including that the instructions further comprise a pre-filtering module, wherein the pre-filtering module prohibits use of one or more rules in the plurality of rules based on an adjustable security level.

Any one or more of the aspects further including that the pre-filtering module further comprises a user interface, wherein the user interface displays the adjustable security level to the user.

Any one or more of the aspects further including that the adjustable security level is a dial.

Any one or more of the aspects further including that, when the security level is set to a first security level, the pre-filtering module prohibits use of a first set of rules of the plurality of rules.

Any one or more of the aspects further including that, when the security level is set to a second security level different from the first security level, the pre-filtering module prohibits use of a second set of rules of the plurality of rules.

Any one or more of the aspects further including that the instructions further comprise a transaction manager, wherein the transaction manager: determines that the user is conducting a first transaction with a third party; determines, based on the first transaction, a first usage rule in the plurality of usage rules; determines, based on the first usage rule, one or more templates required to complete the first transaction; extracts from the one or more templates, a first plurality of data to be sent to the third party; and sends, through the communication interface, the first plurality of data to the third party.

Any one or more of the aspects further including that the transaction manager further: accesses a secret token associated with the user device; and signs, using the secret token, the first plurality of data before sending the first plurality of data to the third party.

Aspects also include a method, comprising: capturing a first biometric modality associated with a user; capturing a second biometric modality associated with the user; verifying the second biometric modality using the first biometric modality; and saving the first biometric modality and the second biometric modality in a database.

Any one or more of the aspects further comprising: selecting the first biometric modality and the second biometric modality; and combining, using a first logic, the first biometric modality and the second biometric modality to form a first fusion template.

Any one or more of the aspects further comprising: creating a first transaction rule, wherein the first transaction rule utilizes the first fusion template to conduct the transaction.

Any one or more of the aspects further comprising: conducting, by a processor, a first transaction with a third party; wherein the processor: determines that the user is conducting the first transaction, determines that the first transaction rule is associated with the first transaction, determines that the first fusion template is required for the first transaction rule, determines that a plurality of data from the first fusion template is required for the first transaction, extracts the plurality of data from the database, and sends the plurality of data to the third party.

Any one or more of the aspects further comprising that the processor: accesses a secret token associated with the user device; and virtually signs, using the secret token, the plurality of data before sending the plurality of data to the third party.

Aspects include a system comprising: a first fusion template, the first fusion template comprising: a first plurality of data associated with a first modality; and a second plurality of data associated with a second modality, wherein the first fusion template is created by logically combining the first plurality of data and the second plurality of data.

Any one or more of the aspects further include that the first fusion template further comprises: a third plurality of data associated with a third modality, wherein the first fusion template is created by logically combining the first plurality of data, the second plurality of data, and the third plurality of data.

Any one or more of the aspects further include that the first fusion template further comprises: a fourth plurality of data associated with a fourth modality, wherein the first fusion template is created by logically combining the first plurality of data, the second plurality of data, the third plurality of data, and the fourth plurality of data.

Any one or more of the aspects further include that the first modality is a fingerprint associated with a user, wherein the second modality is a face scan associated with the user, wherein the third modality is a personal identification number associated with the user, and wherein the fourth modality is a pulse rate associated with the user.

Any one or more of the aspects further include that the system further comprising: a second fusion template, the second fusion template comprising: a fifth plurality of data associated with a fifth modality; and a sixth plurality of data associated with a sixth modality, wherein the second fusion template is created by logically combining the fifth plurality of data and the sixth plurality of data, wherein the first fusion template is digitally authenticated using the second fusion template.

Aspects include a method of providing user data sovereignty, the method comprising: storing, in an IntelliVault of a user device, one or more modalities associated with a user; provisioning, using the IntelliVault, the one or more modalities associated with the user; and utilizing, using the IntelliVault, the one or more modalities associated with the user.

Any one or more of the aspects further include that storing of the one or more modalities further comprises: capturing, by a camera associated with a user device, a first biometric modality associated with the user; capturing, by a microphone associated with the user device, a second biometric modality associated with the user; combining, using a first logic, the first biometric modality and the second biometric modality to create a first fusion template.

Any one or more of the aspects further include that wherein the first logic is one or more of a mathematical logic, an image logic, and/or a combination logic.

Any one or more of the aspects further include that provisioning the one or more modalities further comprises: creating, by a processor, a first rule, wherein the first rule is related to a first transaction and wherein the first rule instructs the processor to utilize the first fusion template to conduct the first transaction.

Any one or more of the aspects further include that utilizing the one or more modalities further comprises: beginning, by the processor over a communication network, the first transaction; identifying, by the processor, a usage rule for the first transaction, wherein the first rule is the usage rule; identifying, by the processor, one or more fusion templates associated with the usage rule, wherein the one or more fusion templates comprise the first fusion template; determining, by the processor, a first plurality of data from the one or more fusion templates required to complete the first transaction; extracting, by the processor, the first plurality of data from the one or more fusion templates; authenticating, by the processor, the first plurality of data; and sending, by the processor, the first plurality of data over the communication network to a first third party to complete the first transaction.

Any one or more of the aspects further include further comprising: combining, using a second logic, the first biometric modality and the second biometric modality to form a second fusion template.

Any one or more of the aspects further include that the second logic is one or more of a mathematical logic, an image logic, and/or a combination logic.

Any one or more of the aspects further include: creating, by a processor, a second rule, wherein the second rule is related to a second transaction and wherein the second rule instructs the processor to utilize the second fusion template to conduct the transaction.

Any one or more of the aspects further include: beginning, by the processor over a communication network, the second transaction; identifying, by the processor, the usage rule for the second transaction, wherein the second rule is the usage rule; identifying, by the processor, the one or more fusion templates associated with the usage rule; determining, by the processor, a second plurality of data from the one or more fusion templates required to complete the second transaction, wherein the second plurality of data is different from the first plurality of data; extracting, by the processor, the second plurality of data from the one or more fusion templates; authenticating, by the processor, the second plurality of data; and sending, by the processor, the second plurality of data over the communication network to a second third party to complete the first transaction.

Any one or more of the aspects further comprising: beginning, by the processor over the communication network, a third transaction; identifying, by the processor, the usage rule for the third transaction, wherein a third rule is the usage rule for the third transaction; identifying, by the processor, the one or more fusion templates associated with the usage rule, wherein the one or more fusion templates comprise the first fusion template and the second fusion template and are associated with the usage rule; determining, by the processor, a third plurality of data from the one or more fusion templates required to complete the third transaction, wherein the third plurality of data is different from the first plurality of data and the second plurality of data; extracting, by the processor, the third plurality of data from the one or more fusion templates; authenticating, by the processor, the third plurality of data; and sending, by the processor, the third plurality of data over the communication network to the first third party to complete the third transaction.

Any one or more of the aspects further comprising: filtering, by the processor and based on a security level of the IntelliVault, a plurality of usage rules associated with the IntelliVault, wherein, when the security level is set to a first security level, the IntelliVault prohibits use of the first rule and allows use of the second rule and the third rule, and wherein, when the security level is set to a second security level, the IntelliVault prohibits use of the second rule and allows use of the first rule and the third rule.

Any one or more of the aspects further include that the filtering further comprises: providing, by the processor, the user an interface to select a desired level of security.

Any one or more of the aspects further include that the interface is a security dial.

Aspects include a system comprising: a means for receiving, from a user, a first biometric modality; a means for receiving, from the user, a second biometric modality; a means for constructing, by logically combining the first biometric modality with the second biometric modality, one or more fusion templates; a means for establishing one or more usage rules for the one or more fusion templates; and a means for transmitting, based on the one or more usage rules, a digital verification package over a network.

Any one or more of the aspects further include wherein the one or more usage rules are changed based on a security value.

Any one or more of the aspects further include wherein the security value is adjusted based on a dial.

Any one or more of the aspects further include wherein the security value changes from a low security level to a high security level, at least one usage rule of the one or more usage rules becomes available for use.

Any one or more of the aspects further include wherein the one or more usage rules are changed based on a usability value.

Any one or more of the aspects further include wherein the usability value is adjusted based on a dial.

Any one or more of the aspects wherein the usability value changes from a high usability level to a low usability level, at least one usage rule of the one or more usage rules becomes available for use.

Any one or more of the aspects further comprising: a means for determining that the user is conducting the first transaction; a means for determining that the first transaction rule of the one or more usage rules is associated with a first transaction; a means for determining that a first fusion template of the one or more fusion templates is required for the first transaction; a means for determining that a plurality of data from the first fusion template is require for the first transaction; a means for extracting the plurality of data from a database; and a means for sending, over the network, the plurality of data to the third party.

Any one or more of the aspects further comprising: a means for accessing a secret token associated with a user device; and a means for signing, using the secret token, the plurality of data before sending the plurality of data to the third party.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A method comprising:
receiving, from a user, an identification of a first biometric modality;
receiving, from the user, an identification of a second biometric modality;
constructing, by logically combining the first biometric modality with the second biometric modality, one or more fusion templates;
establishing one or more usage rules for the one or more fusion templates; and
transmitting, based on the one or more usage rules, a digital verification package over a network for information access.

2. The method of claim 1, wherein the one or more usage rules are changed based on a security value.

3. The method of claim 2, wherein the security value is a dial.

4. The method of claim 1, wherein the one or more usage rules are changed based on a usability value.

5. The method of claim 4, wherein the usability value is a dial.

6. The method of claim 1, further comprising:
conducting a first transaction with a third party, comprising:
determining that the user is conducting the first transaction;
determining that a first transaction rule of the one or more usage rules is associated with the first transaction;
determining that a first fusion template of the one or more fusion templates is required for the first transaction;
determining that a plurality of data from the first fusion template is required for the first transaction;
retrieving the plurality of data from a database; and
sending, over the network, the plurality of data to the third party.

7. The method of claim 6, wherein the conducting the first transaction further comprises:
accessing a secret token associated with the user device; and
signing, using the secret token, the plurality of data before sending the plurality of data to the third party.

8. The method of claim 1, wherein the first biometric modality comprises one or more of a facial scan, a fingerprint scan, a palm scan, an iris scan, a voice scan, and a pulse rate scan.

9. The method of claim 1, wherein the second biometric modality comprises one or more of a facial scan, a fingerprint scan, a palm scan, an iris scan, a voice scan, and a pulse rate scan.

10. A system comprising:
a processor; and
a memory storing instructions for execution by the processor that, when executed by the processor, cause the processor to:
receive, from a user, a first biometric modality;
receive, from the user, a second biometric modality;
construct, by logically combining the first biometric modality with the second biometric modality, one or more fusion templates;
establish one or more usage rules for the one or more fusion templates; and
transmit, based on the one or more usage rules, a digital verification package over a network.

11. The system of claim 10, wherein the one or more usage rules are changed based on a security value.

12. The system of claim 11, wherein the security value is adjusted based on a dial.

13. The system of claim 12, wherein the security value changes from a low security level to a high security level, at least one usage rule of the one or more usage rules becomes available for use.

14. The system of claim 10, wherein the one or more usage rules are changed based on a usability value.

15. The system of claim 14, wherein the usability value is adjusted based on a dial.

16. The system of claim 15, wherein the usability value changes from a high usability level to a low usability level, at least one usage rule of the one or more usage rules becomes available for use.

17. The system of claim 10, wherein the instructions further cause the processor to:
determine that the user is conducting the first transaction;
determine that the first transaction rule of the one or more usage rules is associated with a first transaction;
determine that a first fusion template of the one or more fusion templates is required for the first transaction;
determine that a plurality of data from the first fusion template is require for the first transaction;
extract the plurality of data from a database; and
send, over the network, the plurality of data to the third party.

18. The system of claim 17, wherein the instructions further cause the processor to:
access a secret token associated with a user device; and
sign, using the secret token, the plurality of data before sending the plurality of data to the third party.

19. A non-transitory computer-readable medium comprising a set of instructions stored therein which, when executed by the processor, cause the processor to:
receive, from a user, a first biometric modality;
receive, from the user, a second biometric modality;
construct, by logically combining the first biometric modality with the second biometric modality, one or more fusion templates;
establish one or more usage rules for the one or more fusion templates; and
transmit, based on the one or more usage rules, a digital verification package over a network.

20. The non-transitory medium of claim 19, wherein the one or more usage rules are adjusted with at least one of a security dial and a usability dial.
